(19) United States
(12) Patent Application Publication
(10) Pub. No.: US 2014/0081992 A1
(43) Pub. Date: Mar. 20, 2014

(54) SYSTEMS AND METHODS FOR PROVIDING CUSTOMIZED DESCRIPTIONS RELATED TO MEDIA ASSETS

(71) Applicant: UNITED VIDEO PROPERTIES, INC., Santa Clara, CA (US)

(72) Inventors: Brian Craig Peterson, Barrington, IL (US); Paul T. Stathacopoulos, San Carlos, CA (US)

(73) Assignee: United Video Properties, Inc., Santa Clara, CA (US)

(21) Appl. No.: 13/622,866

(22) Filed: Sep. 19, 2012

(51) Int. Cl. G06F 17/30

(52) U.S. Cl. CPC G06F 17/30386
USPC 707/749; 707/758

(57) ABSTRACT

Systems and methods are described herein for providing customized descriptive assets related to media assets. In one embodiment, processing circuitry may receive a plurality of descriptive data related to a media asset. Each descriptive data may be associated with one or more characteristics, such as a genre or parental rating. The processing circuitry may then access a user profile and compare the characteristics contained within the profile with the characteristics associated with the descriptive data. Based on this comparison, the processing circuitry may generate a customized descriptive asset using at least a subset of the descriptive data.

### BACKGROUND OF THE INVENTION

Traditional electronic program guide (EPG) systems provide users with a wide variety of information regarding available media assets, including the times a media asset is available and the sources on which the media asset may be accessed. Some electronic program guide systems also provide additional information about the media asset, such as episode titles, episode number, actor/actresses appearing in the media asset, and cast information. Such additional information screens may also include descriptive assets such as episode synopses, plot summaries, editorial reviews, user reviews, video previews, trailers, and other descriptions.

Traditional EPG systems typically provide only one version of such descriptive assets. However, these descriptive assets may be made more effective by customizing the descriptive asset to a particular user. For example, a user may find a full editorial review too long to read and prefer a shorter, less dense review. Furthermore, the descriptive asset may be customized to a user's preferences. For example, a video review for a movie may focus on action sequences for fans of action movies and on romantic sequences for fans of romance movies.

Accordingly, there exists a need in the art for providing customized descriptive assets related to media assets.

### SUMMARY OF THE INVENTION

Systems and methods are described herein for providing customized descriptive assets related to media assets. In one embodiment, processing circuitry may receive descriptive data related to a media asset. For example, the processing circuitry may receive text portions which can be assembled to make up a plot summary. Each descriptive data may be associated with one or more characteristics, such as a genre or parental rating. The processing circuitry may then access a user profile and compare the characteristics contained within the profile with the characteristics associated with the descriptive data. Based on this comparison, the processing circuitry may generate a descriptive asset using the descriptive data that best match the user's preferences. For example, the processing circuitry may assemble a text review using text portions which most closely match a user's genre preferences. In this way, descriptive assets may be customized to each user and assembled dynamically based on the user's preferences.

As used herein, “descriptive data” may include any information which describes a media asset. For example, descriptive data may include a text portion, a video clip, an audio clip, a picture, or other graphic. The descriptive data may be assembled to form a descriptive asset. As used herein, “descriptive asset” may refer to any asset which provides a narrative account related to the content of another media asset. For example, a descriptive asset may include a text synopsis, a text review, a video review, a video preview, a trailer, an audio preview, an audio review, a collage, or other assets. The descriptive asset may also include a combination of text, video, or audio, such as a text review with embedded graphics.

As mentioned above, each descriptive data may be associated with one or more characteristics. These may include characteristics related to the content of the data, such as a genre, a parental rating, a mood, a category, an actor/actress, or other content descriptions. The characteristics may also include information about a target demographic audience, such as a target age group or ethnic group. The characteristics may also include a preferred location for the descriptive data. For example, a text portion may be marked as an “introduction” and preferred at the beginning of a descriptive asset.

For text portions, the processing circuitry may scan the text portion and identify key words. Based on these key words, the processing circuitry may automatically assign characteristics to the descriptive data. For example, the processing circuitry may identify “car chase” and “explosion” occurring in the text portion and assign “action” as a characteristic.

In some embodiments, the characteristics may be numerical values. For example, a descriptive data may be associated with media genres and a 0-10 rating for each which shows the prominence of the genre in the descriptive data.

The processing circuitry may access a user profile which contains characteristics associated with the user. These characteristics may reflect the user's preferences and correspond to the characteristics associated with the descriptive data. For example, the user profile may include the user's genre preferences, parental rating restrictions, a mood, interests, content categories, favorite actor/actresses, favorite movies, favorite TV shows, user demographic information, user gender, user location, or other information about the user. These characteristics may also include numerical values, such as a 0-10 rating indicating a user's preference for a certain media characteristic.

In some embodiments, the characteristics contained in the user profile may be derived or compiled from third-party sources. For example, the processing circuitry may access a Facebook™ profile associated with the user to determine the user's favorite movies. Such preferences may be augmented to the existing user profile. The processing circuitry may also import preferences from people associated with the user's social group, such as Facebook™ friends.

The processing circuitry may determine implicit preferences from third-party profiles in addition to explicitly-stated preferences. For instance, the processing circuitry may scan the third-party profile for certain keywords and assign characteristics to the user profile based on the identified keywords. For example, the processing circuitry may identify the words “beach” and “vacation” and add those to the content characteristics that the user might be interested in.

As described above, the processing circuitry may compare the characteristics associated with the descriptive data with characteristics contained in a user profile. In some embodiments, this comparison includes calculating a similarity value. The similarity value may indicate the number of matches between the user profile and the characteristics of the descriptive data. For example, the similarity value may be a number indicating how many genre preferences are common between the user profile and the descriptive data. In such embodiments, a higher similarity value indicates a higher match to the user's preferences. In other embodiments, where the characteristics are numerical values, the similarity value may be a least-squares distance. For example, the processing circuitry may calculate a least-squares distance by subtracting, for each corresponding characteristic, the numerical value in the user profile with the value associated with the data, squaring each of these differences, summing the squared differences, and taking the square root of the sum. In such embodiments, a lower similarity value indicates a lower least-squares distance, and thus a higher match to the user's preferences.

After calculating the similarity values, the processing circuitry may select at least a subset of the descriptive data for generating a descriptive asset. In some embodiments, the selection involves selecting the descriptive data with similarity values that exceed a certain threshold. In some embodiments, a length constraint limits the number of descriptive data that may be selected. The processing circuitry may then generate a descriptive asset by compiling the selected descriptive data.

The processing circuitry may store the generated descriptive asset, either locally on a user's equipment (e.g., TV, DVR, set-top box), or remotely at a remote server. In some embodiments, the user may rate the descriptive asset for quality and/or usefulness, and the user rating may be stored with the descriptive asset.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 illustrates an example of a cross-platform interactive media system in accordance with some embodiments of the present disclosure;

FIG. 5 shows an illustrative characteristic matrix associated with a descriptive data in accordance with some embodiments of the present disclosure;

FIG. 6 shows another illustrative characteristic matrix associated with a descriptive data in accordance with some embodiments of the present disclosure;

FIG. 7 shows an illustrative user profile screen in accordance with some embodiments of the present disclosure;

FIG. 8 shows another illustrative user profile screen in accordance with some embodiments of the present disclosure;

FIG. 9 shows a general settings screen for generating custom descriptions in accordance with some embodiments of the present disclosure;

FIG. 10 shows an illustrative descriptive asset in accordance with some embodiments of the present disclosure;

FIG. 11 shows another illustrative descriptive asset in accordance with some embodiments of the present disclosure;

FIG. 12 shows another illustrative descriptive asset in accordance with some embodiments of the present disclosure;

FIG. 13 shows another illustrative descriptive asset in accordance with some embodiments of the present disclosure;

FIG. 14 illustrates a flow diagram for providing a custom descriptive asset in accordance with some embodiments of the present disclosure;

FIG. 15 illustrates a flow diagram for generating a customized descriptive asset in accordance with some embodiments of the present disclosure;

FIG. 16 illustrates a flow diagram for generating a customized descriptive asset in accordance with some embodiments of the present disclosure;

FIG. 17 illustrates a flow diagram for assigning characteristics to a text portion in accordance with some embodiments of the present disclosure;

FIG. 18 illustrates a flow diagram for importing preferences from third party sources in accordance with some embodiments of the present disclosure;

FIG. 19 illustrates a flow diagram for storing a customized descriptive asset in accordance with some embodiments of the present disclosure;

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as online applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters′ or providers′ logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

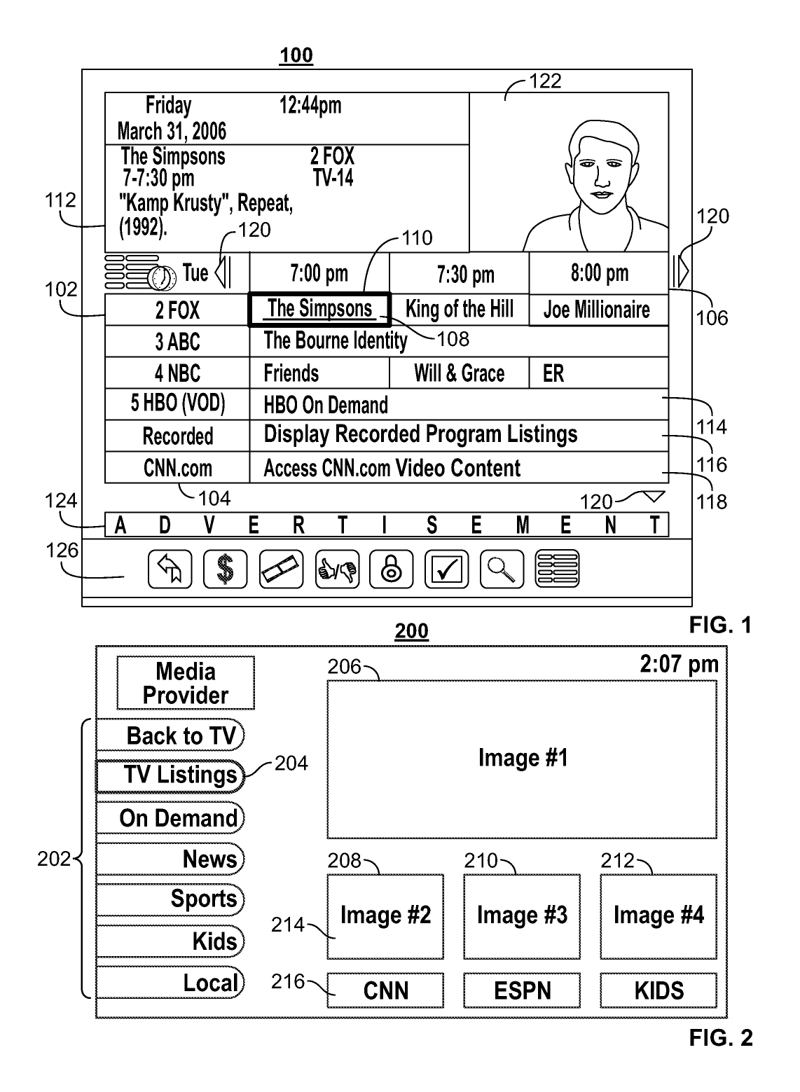

FIGS. 1-2 show illustrative display screens that may be used to provide media guidance data. The display screens shown in FIGS. 1-2 and 5-15 may be implemented on any suitable user equipment device or platform. While the displays of FIGS. 1-2 and 5-15 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

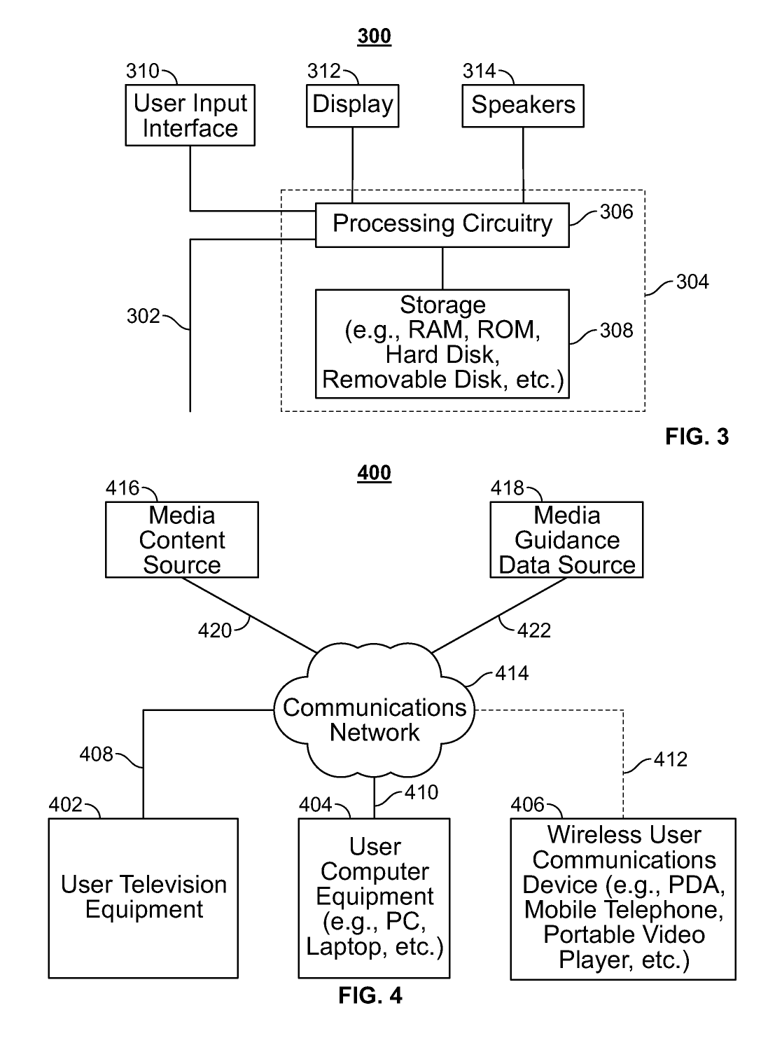

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users′ equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

The media guidance system 400 may provide customized descriptive assets related to media assets. In some embodiments, the user may request additional information about a media asset, for example, by selecting an option from options region 126. Such additional information may include one or more descriptive assets. As used herein, “descriptive asset” may refer to any asset which provides a narrative account related to the content of another media asset. For example, a descriptive asset may include a text synopsis, a text review, a video review, a video preview, a trailer, an audio preview, an audio review, a collage, or other assets. The descriptive asset may also include a combination of text, video, or audio, such as a text review with embedded graphics.

A descriptive asset may be assembled from one or more descriptive data. As used herein, “descriptive data” may include any information which describes a media asset, such as a text portion, a video clip, an audio clip, a picture, or other graphic. For example, descriptive data may be a sentence, a part of a sentence, or multiple sentences which may be combined to form a text description. As another illustrative example, the descriptive data may be a video clip intended to be combined with other clips to produce a video collage as a customized trailer.

In some embodiments, processing circuitry may generate a descriptive asset by combining one or more descriptive data. For example, processing circuitry 306 at user television equipment 402 may receive text portions which can be assembled to make up a plot summary. Each descriptive data may be associated with one or more characteristics, such as a genre or parental rating. The processing circuitry 306 may then access a user profile and compare the characteristics contained within the profile with the characteristics associated with the descriptive data. Based on this comparison, the processing circuitry 306 may generate a descriptive asset using the descriptive data that best match the user's preferences. For example, the processing circuitry may assemble a text review using text portions which most closely match a user's genre preferences. In this way, descriptive assets may be customized to each user and assembled dynamically based on the user's preferences.

Although the embodiments described herein are described in relation to processing circuitry 306 of user equipment 300, it will be generally understood that the methods described herein could be performed at any of the entities in media guidance system 400. For example, media guidance data source 418 may generate descriptive assets and transmit the descriptive asset to user television equipment 402 for presentation to a user. Furthermore, the methods described herein may be executed at a combination of entities in media guidance system 400. For example, media guidance data source 418 may access a user profile which is stored at user television equipment 402, and use the profile to generate a customized descriptive asset. The customized descriptive asset may then be transmitted to user television equipment 402.

As mentioned above, each descriptive data may be associated with one or more characteristics. These may include characteristics related to the content of the data, such as a genre, a parental rating, a mood, a category, an actor/actress, or any other suitable descriptions. The characteristics may also include information about a target demographic audience, such as a target age group or ethnic group. The characteristics may also include a preferred location for the descriptive data. For example, a text portion may be marked as an “introduction” and preferred at the beginning of a descriptive asset.

For text portions, the processing circuitry 306 may scan the text portion and identify key words. Based on these key words, the processing circuitry 306 may automatically assign characteristics to the descriptive data. For example, the processing circuitry 306 may identify “car chase” and “explosion” occurring in the text portion and assign “action” as a characteristic.

In some embodiments, the characteristics may be numerical values. For example, a descriptive data may be associated with media genres and a 0-10 rating for each which shows the prominence of the genre in the descriptive data.

The processing circuitry 306 may access a user profile which contains characteristics associated with the user. These characteristics may reflect the user's preferences and correspond to the characteristics associated with the descriptive data. For example, the user profile may store the user's genre preferences, parental rating restrictions, a mood, interests, content categories, favorite actor/actresses, favorite movies, favorite TV shows, user demographic information, user gender, user location, or any other suitable information about the user. These characteristics may also be numerical values, such as a 0-10 rating indicating a user's preference for a certain media characteristic.

In some embodiments, the characteristics contained in the user profile may be derived or compiled from third-party sources. For example, the processing circuitry 306 may access a Facebook™ profile associated with the user to determine the user's favorite movies. As another illustrative example, the processing circuitry 306 may access a Netflix™ queue or Hulu™ subscription associated with the user to determine a user's preferences or favorite media. As yet another illustrative example, the processing circuitry 306 may access a Twitter™ feed associated with the user to identify the user's media preferences. Such preferences may be augmented to the existing user profile. The processing circuitry 306 may also import preferences from people associated with the user's social group, such as Facebook™ friends.

The processing circuitry 306 may determine implicit preferences from third-party profiles in addition to explicitly-stated preferences. For instance, the processing circuitry 306 may scan the third-party profile for certain keywords and assign characteristics to the user profile based on the identified keywords. For example, the processing circuitry 306 may identify the words “beach” and “vacation” and add those to the content characteristics that the user might be interested in. As another illustrative example, the processing circuitry 306 may identify keywords indicative of certain life events, such as the birth of a new child, and assign a preference to the user profile based on the identified life event.

As described above, the processing circuitry 306 may compare the characteristics associated with the descriptive metadata with characteristics contained in the user profile. In some embodiments, the comparison may include calculating a similarity value. The similarity value may indicate the number of matches between the user profile and the characteristics of the descriptive data. For example, the similarity value may be a number indicating how many genre preferences are common between the user profile and the descriptive data. In such embodiments, a higher similarity value indicates a higher match to the user's preferences. In other embodiments, where the characteristics are numerical values, the similarity value may be a least-squares distance. For example, the processing circuitry 306 may calculate a least-squares distance by subtracting, for each corresponding characteristic, the numerical value in the user profile with the value associated with the data, squaring each of these differences, summing the squared differences, and taking the square root of the sum. In such embodiments, a lower similarity value indicates a lower least-squares distance, and thus a higher match to the user's preferences.

After calculating the similarity values, the processing circuitry 306 may select at least a subset of the descriptive data for generating a descriptive asset. In some embodiments, the processing circuitry 306 selects a subset of the descriptive data with similarity values that exceed a certain threshold. In some embodiments, a length constraint limits the number of descriptive data that may be selected. For example, if the user has indicated in the profile that they dislike long reviews, the descriptive asset may be limited to a certain number of words, sentences, or paragraphs. As another illustrative example, if there is limited space on the display 312 of user equipment 300, it may be desirable to limit the length or size of the descriptive asset so that it can fit on the screen.

The processing circuitry 306 may generate a customized descriptive asset by combining the selected descriptive data. In some embodiments, processing circuitry 306 assembles the customized descriptive assets in no particular order. In other embodiments, the descriptive data may have a characteristic which describes a preferred location. For example, a descriptive data may be marked as an “introduction,” and thus included at the beginning. Other possibilities include descriptive data intended as part of the “body”, “conclusion”, or a specific location or time into the descriptive asset. In some embodiments, certain descriptive data may be marked as alternatives to each other. Extending the “introduction” example above, a second descriptive data may be marked as an “introduction” and used interchangeably with the first descriptive data. In some embodiments, the interchangeable data may be mutually exclusive, that is, only one may be included in the descriptive asset. In such embodiments, the processing circuitry 306 may determine which descriptive data to include in the descriptive asset by comparing the other characteristics of the descriptive data with the user profile to determine the best match. In other embodiments, one descriptive data may be automatically included.

In some embodiments, the processing circuitry 306 may receive several different versions of a descriptive asset, such as different versions of a text review intended for different audiences. In these embodiments, processing circuitry 306 may choose between the different versions by comparing their respective characteristics with the user profile as described above.

The processing circuitry 306 may provide the descriptive asset in any suitable manner. For example, for a text summary, review, or other description, the customized descriptive asset may be displayed on display 312 of user equipment 300. The text description may also be converted by a text-to-speech converter and read aloud to the user through speakers 314 of user equipment 300. For a video review, trailer, or other visual assets, the descriptive asset may be played on user equipment 300. Similarly, audio descriptive assets may be played on speakers 314. Furthermore, the descriptive asset may include a combination of media, such as a customized text review with embedded graphics and a custom song playing in the background. In this way, any descriptive asset which is related to a media asset may be assembled on the fly in a dynamic fashion based on the user's preferences.

The processing circuitry 306 may store the generated descriptive asset, either locally on a user's equipment 300, or remotely at media content source 416, media guidance data source 418, or another remote server. In some embodiments, the user may rate the descriptive asset for quality and/or usefulness, and the user rating may be stored with the descriptive asset. A content provider may analyze the user ratings and customized descriptive assets, for example, for use in other applications or advertising campaigns.

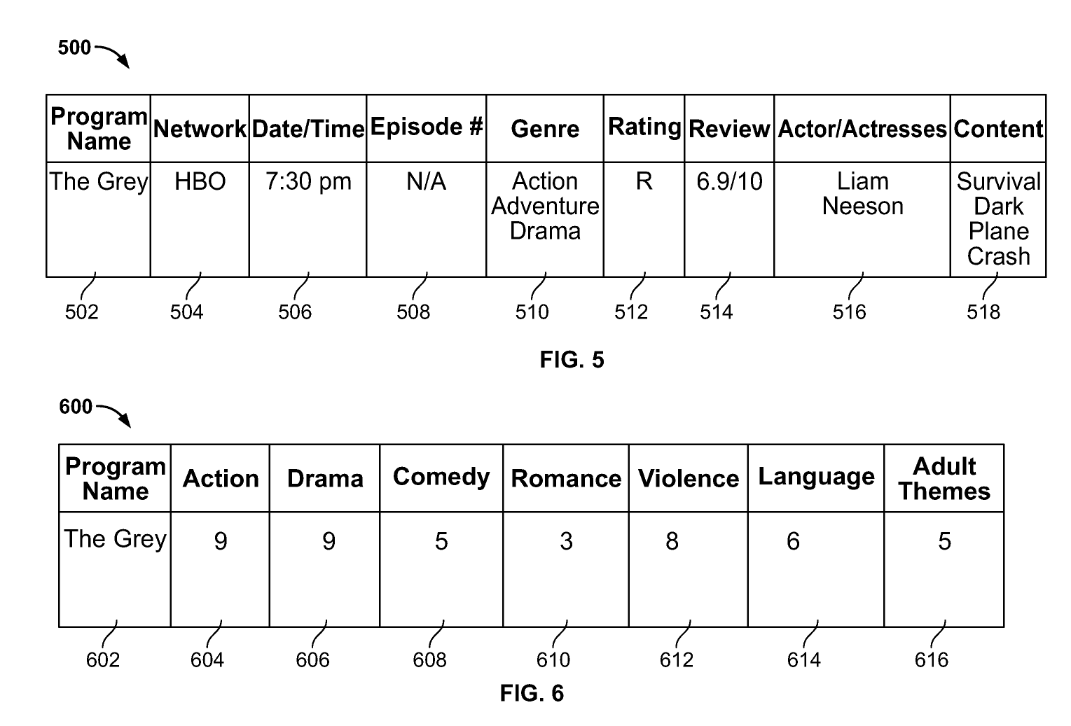

FIG. 5 shows an illustrative characteristic matrix 500 associated with a descriptive data in accordance with some embodiments of the present disclosure. Characteristic matrix 500 includes data entries 502 to 518 which represent characteristics associated with a descriptive data. These characteristics may relate to the associated media asset. For example, data entry 502 lists the program name of the media asset as “The Grey”. Similarly, data entries 504 and 506 show the network and date/time that “The Grey” is scheduled for. Some data entries, such as data entry 508, may be labeled as not applicable or contain a null value. In the example depicted in FIG. 5, “The Grey” relates to a movie and therefore does not correspond to an episode number. Some data entries, such as data entry 510, may include more than one word or characteristic. In the example depicted in FIG. 5, the media asset “The Grey” is associated with the genres “Action”, “Adventure”, and “Drama” as shown in data entry 510.

Some data entries in characteristic matrix 500 may relate to the descriptive data itself. For example, data entry 518, which is labeled “content”, may describe the content contained in the descriptive data. In the example depicted in FIG. 5, the descriptive data may have content that is “dark” and related to “survival” and a “plane crash”. Such content descriptions may be useful for including or excluding certain descriptive data when generating a descriptive asset, as will be discussed further below. As another illustrative example, the data entry 512 may describe the “rating” of the descriptive data. Such characteristics may become useful, for example, for limiting adult language and themes in the generated descriptive asset.

It will be generally understood that the data entries shown in characteristic matrix 500 are for illustrative purposes only, and that any other suitable characteristics and/or data entries will not depart from the scope thereof and may be included for use in the embodiments described herein.

Characteristic matrix 500 may be stored along with the descriptive metadata and transmitted in conjunction with the descriptive data. For example, processing circuitry 306 of user equipment 300 may receive one or more descriptive data, each associated with a characteristic matrix 500. In alternate embodiments, processing circuitry at a remote server, such as media content source 416 or media guidance data source 418, may store the descriptive data and their associated characteristic matrix 500. In some embodiments, the characteristic matrix 500 may be a standard template with a predetermined set of characteristics. In such embodiments, not all of the data entries may be populated for every descriptive data. For example, as discussed above, data entry 508 “Episode number” is not applicable to the movie “The Grey”. Such null or non-populated data entries may also be filled in later using methods described below. For example, a keyword search may automatically add entries to the “Content” data entry 518 to further describe the descriptive data.

FIG. 6 shows another illustrative characteristic matrix 600 associated with a descriptive data in accordance with some embodiments of the present disclosure. Characteristic matrix 600 includes data entries 602 to 616 which represent characteristics associated with a descriptive data. Characteristic matrix 600 may also be included with, or be an extension of, characteristic matrix 500. Data entries 602 to 616 represent numeric values which describe the prominence of certain characteristics. The data entries may relate to either the media asset associated with the descriptive data, or the descriptive data itself. For example, the “Violence” data entry 612 may describe the overall level of action in the movie “The Grey”, or the level of violent themes contained in the descriptive data. Each data entry 602 to 616 may optionally include an indicator which indicates whether the data entry relates to the descriptive data or the associated media asset.

The values contained within data entries 604 to 616 may be any suitable rating for the characteristics shown. In the example depicted in FIG. 6, the entries are numeric ratings from 0-10 indicating the prominence of the genre in the descriptive asset, with 0 representing no prominence and 10 representing the highest level of prominence. Other rating systems may also be used, such as a qualitative letter system (e.g., “A, B, C, D, F”) or a star system (e.g., ***** or “Five Stars” for highest prominence. Both the quantitative number values and the qualitative ratings may be useful for generating a descriptive asset, as described further below. For example, certain descriptive data may be included or excluded depending on their content ratings. As an illustrative example, the descriptive data may be excluded for including a certain level of violence.

It will be generally understood that the data entries shown in characteristic matrix 600 are for illustrative purposes only, and that any other suitable characteristics and/or data entries will not depart from the scope thereof and may be included for use in the embodiments described herein.

Characteristic matrix 600 may be stored along with the descriptive data and transmitted in conjunction with the descriptive data. For example, processing circuitry 306 of user equipment 300 may receive one or more descriptive data, each associated with a characteristic matrix 600. In alternate embodiments, processing circuitry at a remote server, such as media content source 416 or media guidance data source 418, may store the descriptive data and their associated characteristic matrix 600. In some embodiments, the characteristic matrix 600 may be a standard template with a predetermined set of characteristics. In such embodiments, not all of the data entries may be populated for every descriptive data. For example, the data entry may not be applicable to the descriptive data or media asset. In other instances, the data entry may simply be incomplete, and be populated at a later time.

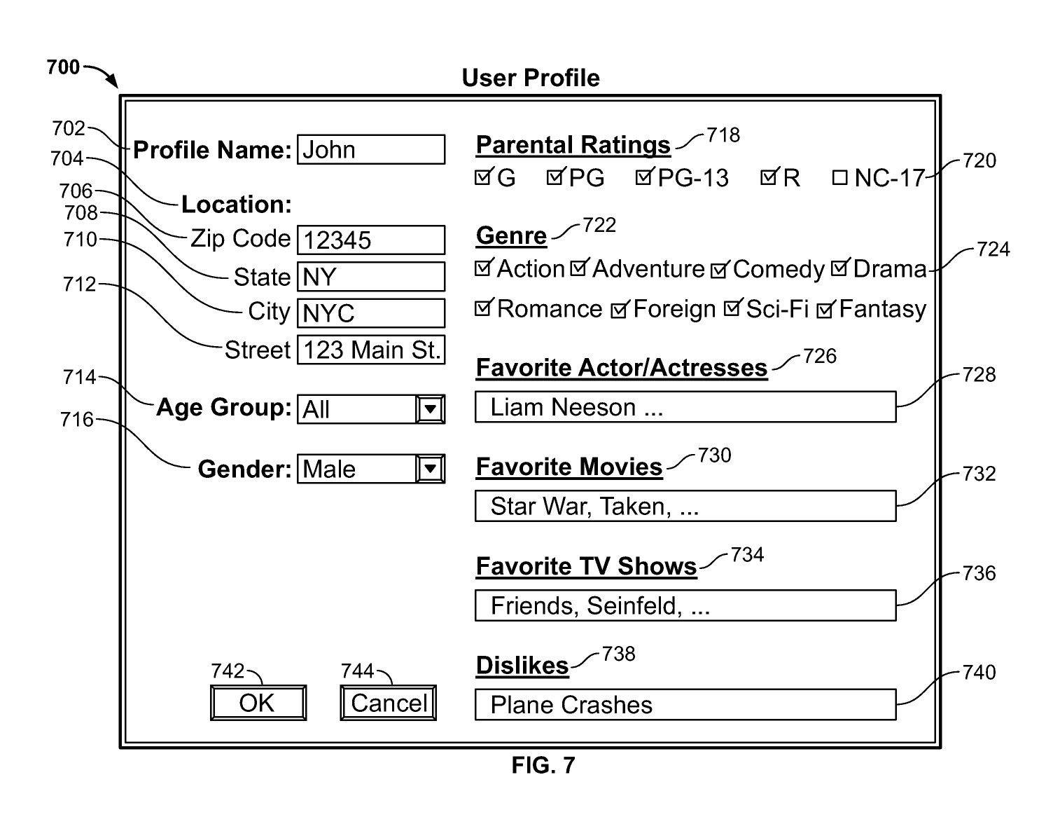

FIG. 7 shows an illustrative user profile screen 700 in accordance with some embodiments of the present disclosure. In some embodiments, user profile screen 700 may be invoked inside a media guidance application screen, such as those depicted in FIG. 1 or FIG. 2. For example, user profile screen 700 may be invoked by selecting an option in options region 126. The user profile screen 700 may allow the user to input his or her characteristics and/or preferences in entries 708 to 740 to be stored in a user profile. As used herein, “user profile” may pertain to any data file or structure which contains information corresponding to a user, such as information entered into user profile screen 700. The user profile may be stored either locally at the user equipment, such as at user equipment 402, or remotely, such as at media content source 416 or media guidance data source 418. The user profile may also be stored at a combination of two or more entities in media guidance system 400. As an illustrative example, a basic user profile may be stored at media content source 416, while a more specific user profile detailing the user's preferences may be stored locally at user television equipment 402.

User profile screen 700 may be displayed on any suitable display, such as display 312 associated with user equipment 300. The user profile screen 700 may also be a part of a website displayed, for example, on user computer equipment 404. The user profile screen 700 may contain information input by the user using two or more types of user equipment, such as user television equipment 402, user computer equipment 404, and user television equipment 406. As an illustrative example, the user may enter some preferences using a mobile device, which is then integrated into the user's profile. Such embodiments may employ any of the cloud features as discussed above.

The user profile screen 700 may also include implicitly derived user characteristics and preferences, in addition to characteristics and preferences explicitly entered by the user. For example, processing circuitry 306 at user equipment 300 may monitor the user's browsing and/or media consumption habits to implicitly derive the user's preferences. As an illustrative example, the processing circuitry 306 may observe that the user primarily watches sports programs and automatically add “sports” as a preferred genre. The user profile screen 700 may include an option for implicitly assigning preferences and characteristics.

The user profile screen 700 may include entries for entering user demographic information, as illustrated by entries 702 to 716. The user may enter a profile name into data entry 702. Data entry 702 may include a selectable region which allows the user to input text. Text may be input in any suitable fashion, for example using a keyboard, a remote control, or other user input device or interface. A speech-to-text converter, as is known in the art, may be used to receive speech input from the user and automatically convert it into an entry on user profile screen 700. User profile screen 700 may include entries 704 and 712 for entering a user location. In the example depicted in FIG. 7, the user may enter a zip code, state, city, and street into entries 706 and 712. The user may enter an age group into entry 714. The user may enter a specific age, or be presented with several age ranges to choose from. Upon selection, entry 714 may present a scroll window with selectable choices for user convenience. In other embodiments, entry 714 may be a text entry, such as entry 702. The user may enter a gender into entry 716. As with any of the entries on user profile screen 700, entry 716 may employ a text input, scroll window, or any other suitable data entry procedure. Any other suitable demographic information may be entered by the user as will be understood by those of ordinary skill in the art.

The user may enter his or her preferences into entries 718 to 740. Heading 718 denotes a section allowing the user to enter preferred parental ratings 720. Ratings 720 may be any suitable ratings, such as those provided by the Motion Picture Association of America, as shown. Ratings 720 may also include check boxes, or any other suitable user input, to denote preferred ratings. The preferred ratings may also be input from a separate parental control feature operative on the user equipment. In such embodiments, any “locked” ratings may automatically be indicated on the user profile screen 700. In some embodiments, the locked ratings may be unable to be selected until the unlocked in the separate parental control feature. Such locked ratings may be “greyed-out” or otherwise visually distinguished from the other ratings.

The user may input their favorite genres into heading 722. As with ratings 720, genres 724 may include check boxes or other suitable user input for indicating the user's preferred genres. As discussed above, user profile screen 700 may also automatically determine user preferences, for example by monitoring user habits, and indicate them on the user profile screen. Heading 722 may also include a text input allowing the user to input custom genres or keywords that the user is interested in. The processing circuitry 306 may also import preferences from other applications running on the user equipment or from third-party sources such as Facebook™.

The user may input their favorite actor/actresses, movies, and TV shows into entries 728, 732, and 736 under headings 726, 730, and 734. Similar to the other headings, headings 726, 730, and 734 may be determined implicitly, for example through the user's monitored habits, or imported from other applications or third-party sources.

The user may input explicit dislikes under heading 738 in entry 740. Entry 740 may include a text input which allows the user to enter keywords. As an illustrative example, if the user is afraid of plane crashes, the user may input “plane crash” into entry 740. Such information may be useful for tailoring customized descriptive assets, as will be discussed further below.

User profile screen 700 may include an “OK” button 742 for confirming their choices. Upon selecting button 742, the user profile may be stored on any suitable storage device, such as storage 308 of user equipment 300. User profile screen 700 may also include a “Cancel” button 744. Upon selecting button 744, any modifications or inputs made by the user may be discarded.

As will be understood by those of ordinary skill in the art, the user input screen 700 is shown merely for illustrative purposes only, and any other suitable entries, inputs, or interfaces may be included in user profile screen 700 without departing from the scope thereof of the present disclosure.

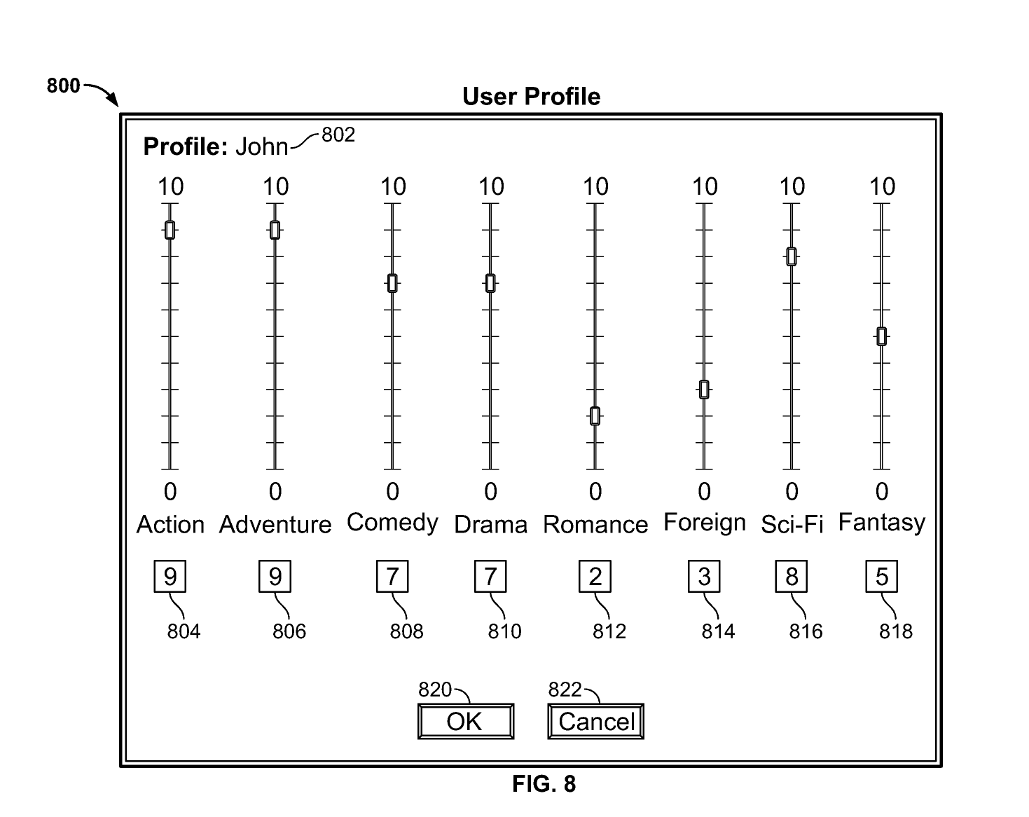

FIG. 8 shows another illustrative user profile screen 800 in accordance with some embodiments of the present disclosure. In some embodiments, user profile screen 800 may be invoked inside a media guidance application screen, such as those depicted in FIG. 1 or FIG. 2. For example, user profile screen 800 may be invoked by selecting an option in options region 126. User profile screen 800 may be presented instead of, or in addition to, user profile screen 700. The information entered into user profile screen 800 may be stored in a user profile. The user profile may be stored either locally at the user equipment, such as at user equipment 402, or remotely, such as at media content source 416 or media guidance data source 418. The user profile may also be stored at a combination of two or more entities in media guidance system 400. As an illustrative example, a basic user profile may be stored at media content source 416, while a more specific user profile detailing the user's preferences may be stored locally at user television equipment 402.

User profile screen 800 may be displayed on any suitable display, such as display 312 associated with user equipment 300. The user profile screen 800 may also be a part of a website displayed, for example, on user computer equipment 404. The user profile screen 800 may contain information input by the user using two or more types of user equipment, such as user television equipment 402, user computer equipment 404, and user television equipment 406. As an illustrative example, the user may enter some preferences using a mobile device, which is then integrated into the user's profile. Such embodiments may employ any of the cloud features as discussed above.

Similar to user profile screen 700, user profile screen 800 includes an entry 802 for the profile name. The entries 804 to 818 may be used by the user to input the user's preferences for certain characteristics. In the example depicted in FIG. 8, the user may input preferences in the form of numerical values from 0 to 10 for certain genres. Although entries 804 to 818 are depicted as scroll bars, any suitable user input method may be used to receive the user's preferences. In addition, any suitable method may be used to rate the various characteristics, including a letter system (e.g., “A”, “B”, “C”, “D”, “F”) or a star system (“*****” or “Five stars” for high preference). Other rating systems may be contemplated and do not depart from the scope of the disclosure.

Entries 804 to 818 may also include text input boxes which allow the user to manually input a number or other rating via a suitable input interface. In some embodiments, the scroll bar and the text input may be synchronized, such that entering a number into the text input automatically moves the scroll bar to the corresponding number. Other graphical presentations and orientations may be used as will be understood by those of ordinary skill in the art.

The user profile screen 800 may also include implicitly derived user characteristics and preferences, in addition to characteristics and preferences explicitly entered by the user. For example, processing circuitry 306 at user equipment 300 may monitor the user's browsing and/or media consumption habits to implicitly derive the user's preferences. As an illustrative example, the processing circuitry 306 may observe that the user primarily watches sci-fi movies and increase the preference rating of “Sci-Fi”. The user profile screen 800 may include an option for monitoring user habits and implicitly deriving preferences and characteristics.

User profile screen 800 may include an “OK” button 820 for confirming their choices. Upon selecting button 820, the user profile may be stored on any suitable storage device, such as storage 308 of user equipment 300. User profile screen 800 may also include a “Cancel” button 822. Upon selecting button 822, any modifications or inputs made by the user may be discarded.

As will be understood by those of ordinary skill in the art, the user input screen 800 is shown merely for illustrative purposes only, and any other suitable entries, inputs, or interfaces may be included in user profile screen 800 without departing from the scope thereof of the present disclosure.

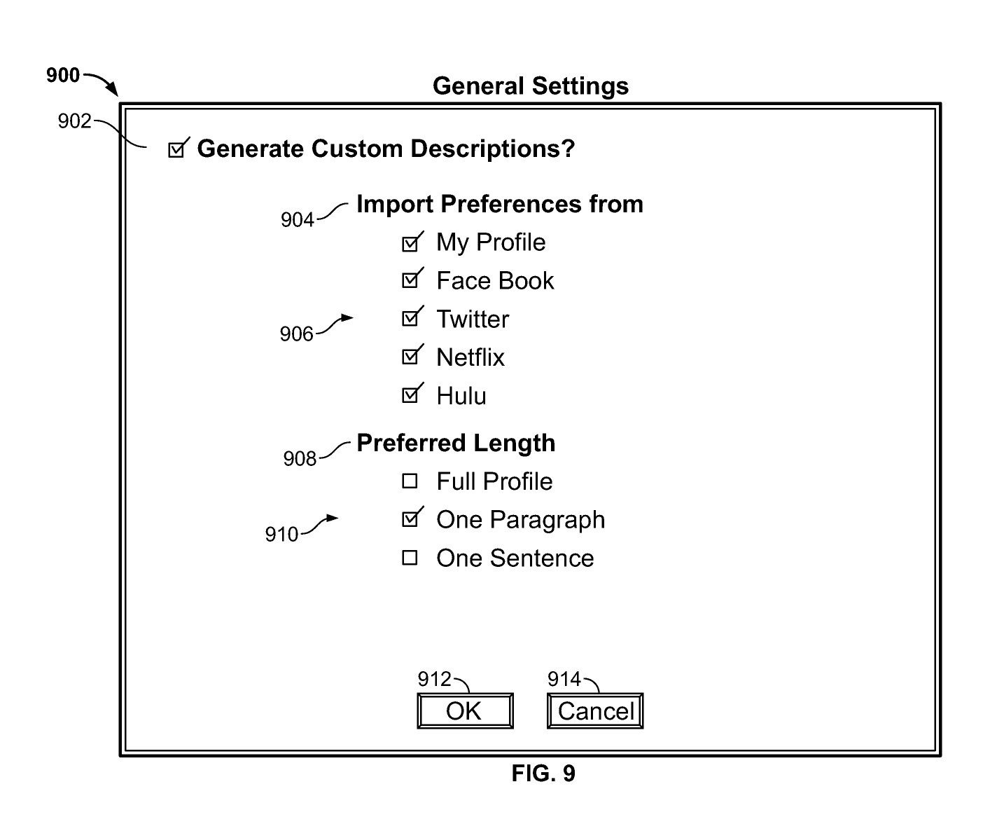

FIG. 9 shows a general settings screen 900 for generating custom descriptions in accordance with some embodiments of the present disclosure. In some embodiments, general settings screen 900 may be invoked inside a media guidance application screen, such as those depicted in FIG. 1 or FIG. 2. For example, general settings screen 900 may be invoked by selecting an option in options region 126. General settings screen 900 may allow the user to input settings using entries 902 to 910. These entries may be presented in addition to an existing general settings screen of a media guidance application. The information entered into entries 902 to 910 may be stored together with the user profile or as a separate data file. If the settings are stored as a separate data file, the settings file may be stored either locally at the user equipment, such as at user equipment 402, or remotely, such as at media content source 416 or media guidance data source 418. The settings file may also be stored at a combination of two or more entities in media guidance system 400. As an illustrative example, basic settings may be stored at media content source 416, while settings more specific to a user equipment may be stored locally at user television equipment 402.

General settings screen 900 may be displayed on any suitable display, such as display 312 associated with user equipment 300. The general settings screen 900 may also be a part of a website displayed, for example, on user computer equipment 404. The general settings screen 900 may contain information input by the user using two or more types of user equipment, such as user television equipment 402, user computer equipment 404, and user television equipment 406. As an illustrative example, the user may enter some preferences using a mobile device, which is then integrated into the user's profile. Such embodiments may employ any of the cloud features as discussed above.

General settings screen 900 may include entry 902 querying the user whether to generate custom descriptions. Entry 902 may include a check box or any other suitable user input for allowing a user to indicate a preference. If entry 902 is not selected by the user, or the user indicates that custom descriptions should not be generated, the entries 904-910 may be “greyed-out” or visually distinguished and/or be unselectable.

Entries 904-910 may allow a user to select certain options for generating descriptive assets. Entry 904 may query the user to indicate which profiles to use for the user's preferences. The entries 906 my include the user's locally-stored profile as well as profiles at third-party sources, such as Facebook™, Twitter™, Netflix™, Hulu™, or other third-party sources. Entries 904-910 may include check boxes or any other suitable user input interface for selecting the entries.

Entries 908 and 910 may allow the user to input a preferred length for the generated descriptive assets. Entries 910 may include check boxes or any other suitable user input interface for selecting the entries. In the example depicted in FIG. 9, the choices include the full profile, one paragraph, or one sentence, depending on how long the user prefers text descriptions. For example, the user may not prefer full editorial reviews, and may instead prefer shorter pieces of information so that he or she can browse many media assets quickly. Other options may be included for the preferred length, including a word count, number of paragraphs, number of pages, length of time, or other suitable options.

General settings screen 900 may include an “OK” button 912 for confirming their choices. Upon selecting button 912, the settings may be stored on any suitable storage device, such as storage 308 of user equipment 300. General settings screen 900 may also include a “Cancel” button 914. Upon selecting button 914, any modifications or inputs made by the user may be discarded.

As will be understood by those of ordinary skill in the art, the general settings screen 900 is shown merely for illustrative purposes only, and any other suitable entries, inputs, or interfaces may be included in general settings screen 900 without departing from the scope thereof of the present disclosure.

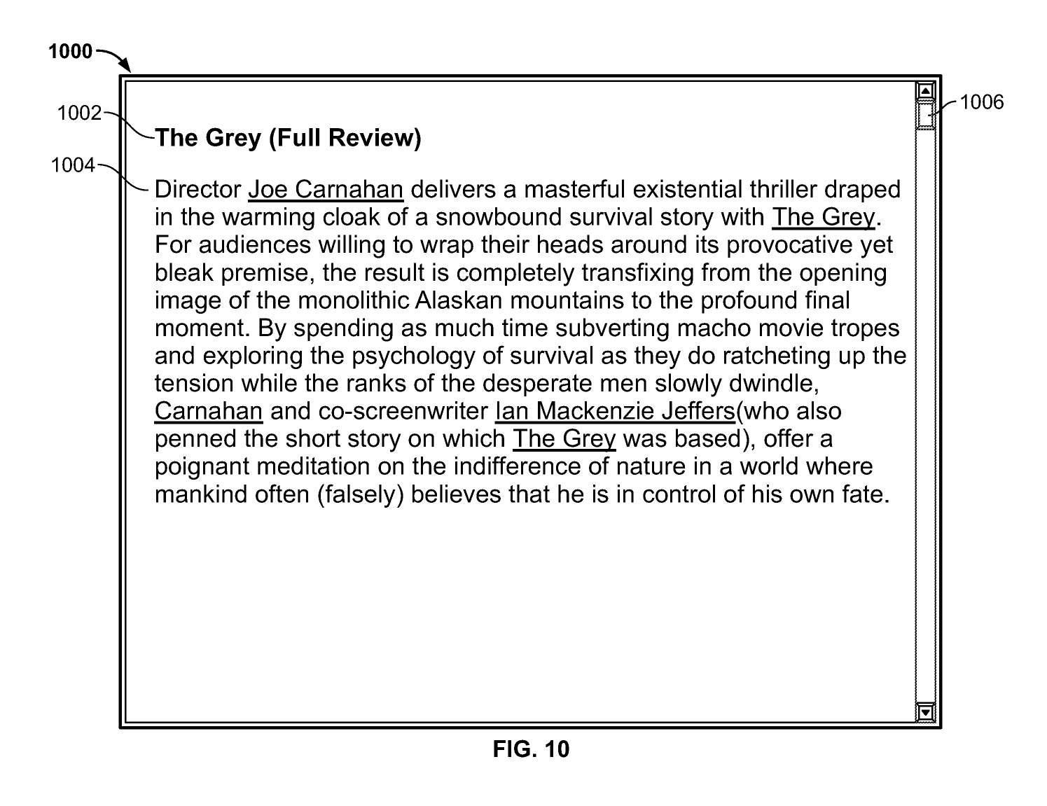

FIGS. 10-13 show illustrative examples of a descriptive asset in accordance with some embodiments of the present disclosure. Although the descriptive assets 1000, 1100, 1200, and 1300 are discussed in relation to a text description, other descriptive assets may be contemplated, such as a video clip, audio clip, or a combination of text, video, and audio. The descriptive assets may be displayed on any suitable display, such as display 312 associated with user equipment 300. The descriptive asset may also be a part of a website displayed, for example, on user computer equipment 404.

In the example depicted in FIG. 10, a descriptive asset 1000 is presented as a full written review of the movie “The Grey”. The descriptive asset 1000 may be invoked inside a media guidance application screen, such as those depicted in FIG. 1 or FIG. 2. For example, descriptive asset 1000 may be invoked by selecting an option in options region 126, such as a “more information” or similar option. The descriptive asset 1000 may represent a full written editorial review, as shown in element 1004. The user may scroll down using scroll bar 1006. The descriptive asset may also include title 1002, indicating that it is the full review.

The descriptive asset 1000 may be transmit prior to a user request for the asset and stored to the local user equipment, such as in storage 308 of user equipment 300. In alternate embodiments, the descriptive asset 1000 may be transmitted “on-demand” in response to a user request for the asset. In some embodiments, only one version of the full review may be sent to the user equipment 300. This may be because the user selected not to receive customized descriptive assets on general settings screen 900. In other embodiments, several versions of the full review may be sent to the user equipment 300. For example, full reviews written by different authors may be sent to the user equipment 300. The processing circuitry 306 may decide which review to present to the user by comparing the characteristics in the user profile with the characteristics associated with each of the descriptive assets. Such selection methods are further discussed below in relation to flow diagrams 14-19.

As will be understood by those of ordinary skill in the art, the descriptive asset 1000 is shown merely for illustrative purposes only, and any other suitable entries, inputs, or interfaces may be included along with descriptive asset 1000 without departing from the scope thereof of the present disclosure.

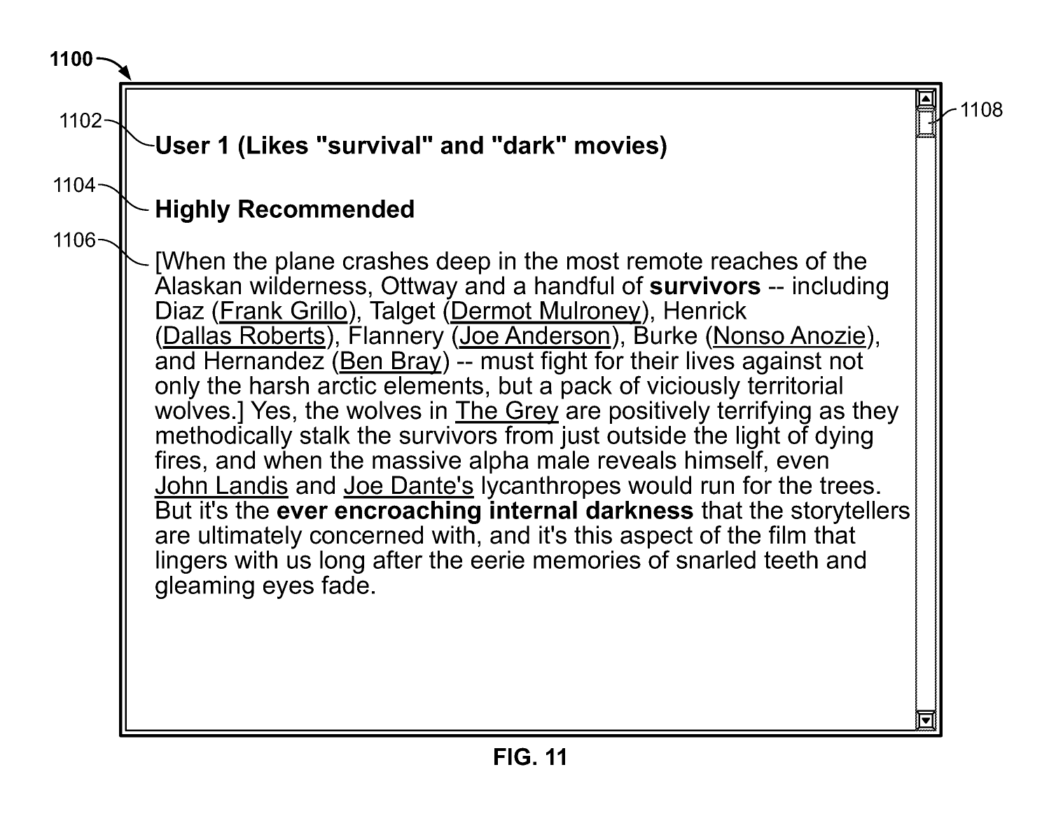

FIG. 11 shows another illustrative descriptive asset 1100 in accordance with some embodiments of the present disclosure. The descriptive asset 1100 may be invoked inside a media guidance application screen, such as those depicted in FIG. 1 or FIG. 2. For example, descriptive asset 1100 may be invoked by selecting an option in options region 126, such as a “more information” or similar option.

In the example depicted in FIG. 11, the descriptive asset 1100 is presented as a customized review for the movie “The Grey” tailored for users who like “survival” and “dark” movies. This fact may be reflected in title 1102, which indicates the characteristics which the descriptive asset has in common with the user. In some embodiments, title 1102 may not be included, or may not indicate the characteristics which the descriptive asset has in common with the user. The descriptive asset 1100 may also include recommendation 1104. In this example, the review is “highly recommended”, because it contains “dark” and “survival” themes, which the given user enjoys. These characteristics may be listed, for example, in characteristics matrix 500 for the descriptive asset and user profile 700 for the user. Similar to descriptive asset 1000, the user may scroll down using scroll bar 1108.

Descriptive asset 1100 may also be assembled from one or more descriptive data. For example, element 1106, which is the first sentence of the descriptive asset 1100, may be a descriptive data. Element 1106 may be associated with its own characteristic matrix 500, and may have been chosen because it also reflects “dark” and “survival” themes. Although element 1106 represents a descriptive data that is a full sentence descriptive data could also be parts of a sentence, more than one sentence, one or more paragraphs, one or more pages, or any other suitable portion. In descriptive data that are not textual, the descriptive data may be any suitable portion, such as a video clip, an audio clip, or an image.

The descriptive asset 1100 may be transmit prior to a user request for the asset and stored to the local user equipment, such as in storage 308 of user equipment 300. In alternate embodiments, the descriptive asset 1100 may be transmitted “on-demand” in response to a user request for the asset. Similarly, the descriptive asset 1100 may have been assembled from one or more descriptive data either before a user request for the descriptive asset 1100, or in response to such a user request. As discussed above in relation to FIG. 10, the processing circuitry 306 may decide which descriptive asset to present to the user by comparing the characteristics in the user profile with the characteristics associated with each of the descriptive assets. Furthermore, the processing circuitry 306 may generate descriptive asset 1100 by comparing characteristics in the user profile with characteristics associated with descriptive data, and selecting appropriate descriptive data based on the comparison. Such selection and generation methods are further discussed below in relation to flow diagrams 14-19.

As will be understood by those of ordinary skill in the art, the descriptive asset 1100 is shown merely for illustrative purposes only, and any other suitable entries, inputs, or interfaces may be included along with descriptive asset 1100 without departing from the scope thereof of the present disclosure.

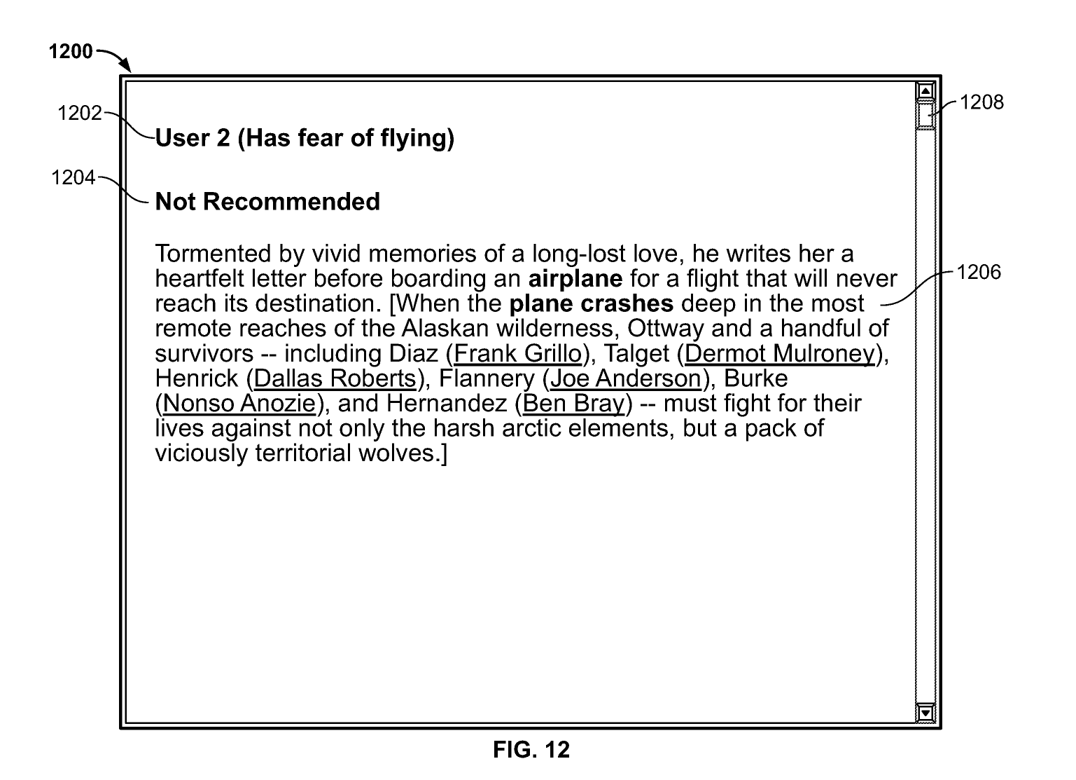

FIG. 12 shows another illustrative descriptive asset 1200 in accordance with some embodiments of the present disclosure. The descriptive asset 1200 may be invoked inside a media guidance application screen, such as those depicted in FIG. 1 or FIG. 2. For example, descriptive asset 1200 may be invoked by selecting an option in options region 126, such as a “more information” or similar option.

In the example depicted in FIG. 12, the descriptive asset 1200 is presented as a customized review for the movie “The Grey” tailored for users who dislike movies about plane crashes. This fact may be reflected in title 1202, which indicates the characteristics which the descriptive asset has in common with the user. In some embodiments, title 1202 may not be included, or may not indicate the characteristics which the descriptive asset has in common with the user. The descriptive asset 1200 may also include recommendation 1204. In this example, the review is “not recommended”, because it mentions plane crashes. Such relevant keywords, such as “plane crashes” and “airplane”, may be highlighted in descriptive asset 1200, as shown in FIG. 12. These user dislikes may be listed, for example, in user profile 700 and in characteristics matrix 500 for the descriptive asset. Similar to descriptive assets 1000 and 1100, the user may scroll down using scroll bar 1208.

Descriptive asset 1100 may also be assembled from one or more descriptive data. For example, element 1206, which is the same as element 1106 in descriptive asset 1100, may be included in the descriptive asset. Element 1206 may be associated with its own characteristic matrix 500, and may have been chosen despite containing themes that the user dislikes. For example, element 1206 may be automatically included in some descriptive assets.

The descriptive asset 1200 may be transmit prior to a user request for the asset and stored to the local user equipment, such as in storage 308 of user equipment 300. In alternate embodiments, the descriptive asset 1200 may be transmitted “on-demand” in response to a user request for the asset. Similarly, the descriptive asset 1200 may have been assembled from one or more descriptive data either before a user request for the descriptive asset 1200, or in response to such a user request. As discussed above in relation to FIG. 10, the processing circuitry 306 may decide which descriptive asset to present to the user by comparing the characteristics in the user profile with the characteristics associated with each of the descriptive assets. Furthermore, the processing circuitry 306 may generate descriptive asset 1200 by comparing characteristics in the user profile with characteristics associated with descriptive data, and selecting appropriate descriptive data based on the comparison. Such selection and generation methods are further discussed below in relation to flow diagrams 14-19.

As will be understood by those of ordinary skill in the art, the descriptive asset 1200 is shown merely for illustrative purposes only, and any other suitable entries, inputs, or interfaces may be included along with descriptive asset 1200 without departing from the scope thereof of the present disclosure.

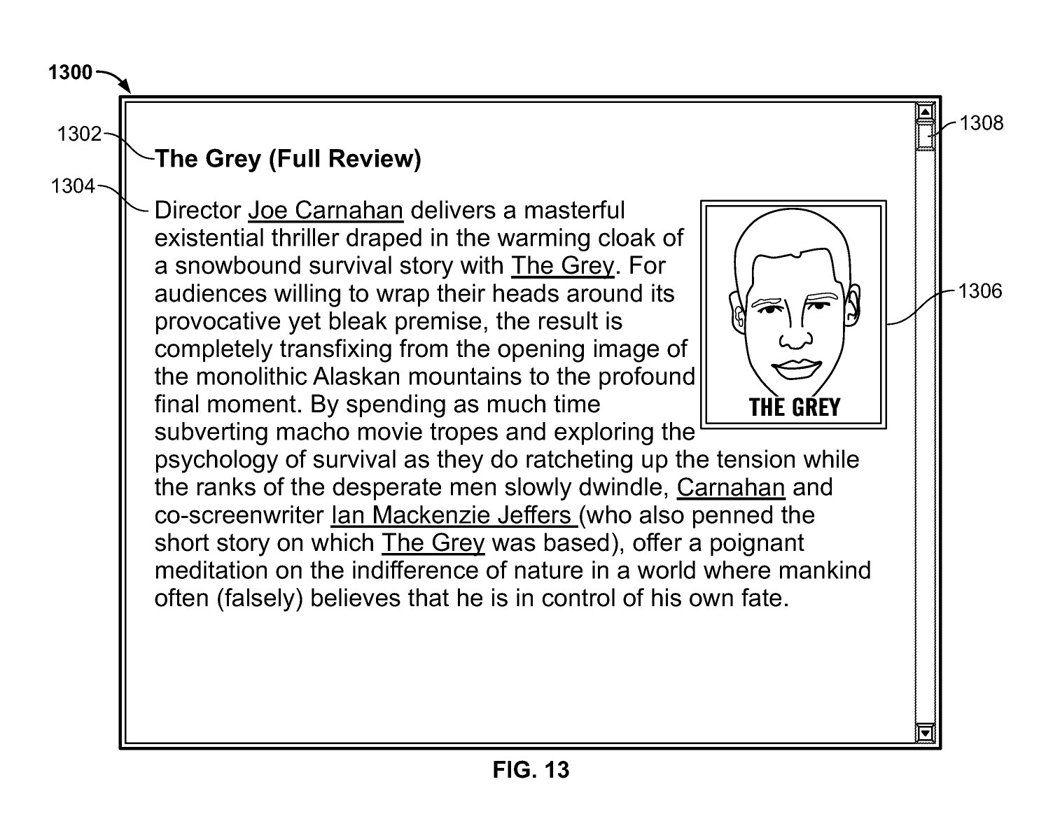

FIG. 13 shows another illustrative descriptive asset 1300 in accordance with some embodiments of the present disclosure. The descriptive asset 1300 may be invoked inside a media guidance application screen, such as those depicted in FIG. 1 or FIG. 2. For example, descriptive asset 1300 may be invoked by selecting an option in options region 126, such as a “more information” or similar option.

In the example depicted in FIG. 13, the descriptive asset 1300 is presented as a full review for the movie “The Grey”, including image 1306. In some embodiments, title 1302 may indicate the descriptive asset is a full review, and in alternate embodiments, the title may simply recite the title of the media asset or be left out completely. Similar to descriptive asset 1000, the user may scroll down using scroll bar 1308.

The descriptive asset 1300 may be transmit prior to a user request for the asset and stored to the local user equipment, such as in storage 308 of user equipment 300. In alternate embodiments, the descriptive asset 1300 may be transmitted “on-demand” in response to a user request for the asset. In some embodiments, only one version of the full review may be sent to the user equipment 300. This may be because the user selected not to receive customized descriptive assets on general settings screen 900. In other embodiments, several versions of the full review may be sent to the user equipment 300. For example, full reviews written by different authors may be sent to the user equipment 300. The processing circuitry 306 may decide which review to present to the user by comparing the characteristics in the user profile with the characteristics associated with each of the descriptive assets. Such selection methods are further discussed below in relation to flow diagrams 14-19.

Image 1306 may be associated with its own characteristic matrix 500 and may have been chosen based on a comparison of its characteristics with the characteristics in a user profile. In this way, the embedded images, such as image 1306, may be tailored to the user based on the preferences, even if the full review is not assembled dynamically from descriptive data. Thus, user equipment 300 may receive several different types of descriptive data, including text portions, video clips, images, audio clips, and other media that may be assembled to form a customized descriptive asset.

As will be understood by those of ordinary skill in the art, the descriptive asset 1300 is shown merely for illustrative purposes only, and any other suitable entries, inputs, or interfaces may be included along with descriptive asset 1300 without departing from the scope thereof of the present disclosure.

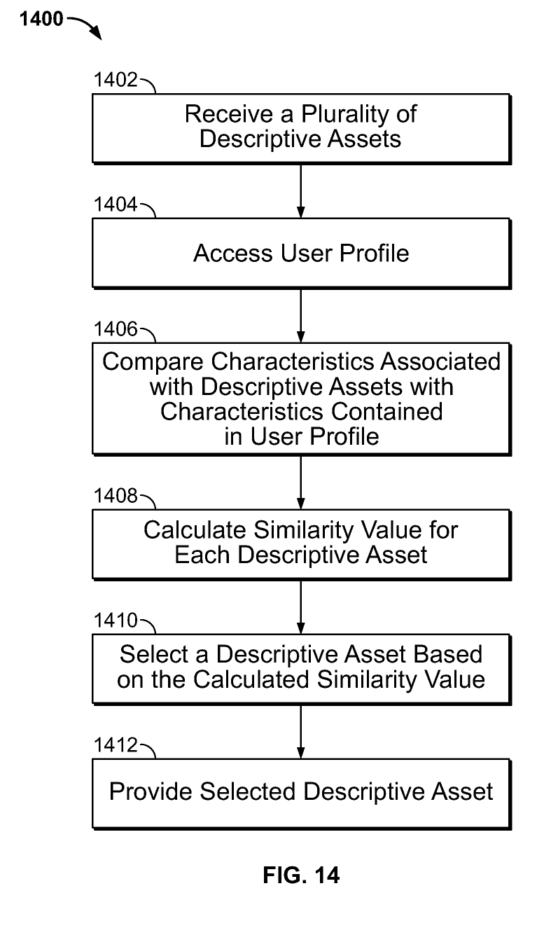

FIG. 14 illustrates a flow diagram 1400 for providing a custom descriptive asset in accordance with some embodiments of the present disclosure. The steps of flow diagram 1400 are performed by a processing device, such as processing circuitry 306 of user equipment 300. In certain embodiments, a similar processing device at a remote server, such as the media content source 416 or media guidance data source 418, may perform the steps of flow diagram 1400. In yet other embodiments, the steps of flow diagram 1400 may be performed by a combination of processing devices at one or more of the entities in media guidance system 400.

At step 1402, the processing device may receive descriptive assets. Each of the descriptive assets may be associated with a characteristic matrix, such as characteristic matrix 500 or 600. The descriptive assets may be received prior to a user request for a descriptive asset, or in response to a request for such an asset. At step 1404, the processing device may access a user profile. The user profile may contain characteristics and preferences associated with the user, as discussed above in relation to user profile screens 700 and 800.

At step 1406, the processing device may compare the characteristics associated with the descriptive assets with characteristics contained in the user profile. In some embodiments, the comparison may entail determining how many characteristics are in common between the descriptive asset and the user. For example, the processing device may determine that the characteristic matrix and the user profile both list the same three genres. In other embodiments, the comparison may entail a quantitative calculation. For example, the characteristics in the characteristic matrix and user profile may be numeric values. In such embodiments, the processing device may be able to calculate a quantitative number representing the similarity between the descriptive asset and the user.

At step 1408, the processing device calculates a similarity value for each descriptive asset. As used herein, a “similarity value” is any indicator which represents the similarity between the descriptive asset and the user. As described above, the similarity value can simply be the number of characteristic matches between the characteristic matrix of the descriptive asset and the user profile. In such embodiments, a higher similarity value for a descriptive asset represents more characteristic matches, and thus a closer match to the user profile. In other embodiments, the similarity value may be a quantitative number. For example, when the characteristics are numerical values, the processing device may calculate a least-squares distance between the characteristics of the descriptive asset and the characteristics of the user profile. For example, the processing device may calculate a least-squares distance by subtracting, for each corresponding characteristic, the numerical value in the user profile with the value associated with the asset, squaring each of these differences, summing the squared differences, and taking the square root of the sum. In such embodiments, a lower similarity value indicates a lower least-squares distance, and thus a higher match to the user's preferences.

At step 1410, after calculating the similarity values, the processing device may select a descriptive asset based on the similarity values. In some embodiments, the processing device selects the descriptive asset with the closest relevance to the user. As discussed above, this could be the descriptive asset with either the highest or lowest similarity value, depending on how the similarity values were calculated.

At step 1412, the descriptive asset may provide the descriptive asset in any suitable manner. For example, for a text summary, review, or other description, the customized descriptive asset may be displayed on display 312 of user equipment 300. The text description may also be converted by a text-to-speech converter and read aloud to the user through speakers 314 of user equipment 300. For a video review, trailer, or other visual assets, the descriptive asset may be played on user equipment 300. Similarly, audio descriptive assets may be played on speakers 314. Furthermore, the descriptive asset may include a combination of media, such as a customized text review with embedded graphics and a custom song playing in the background. In this way, any descriptive asset which is related to a media asset may be assembled on the fly in a dynamic fashion based on the user's preferences.

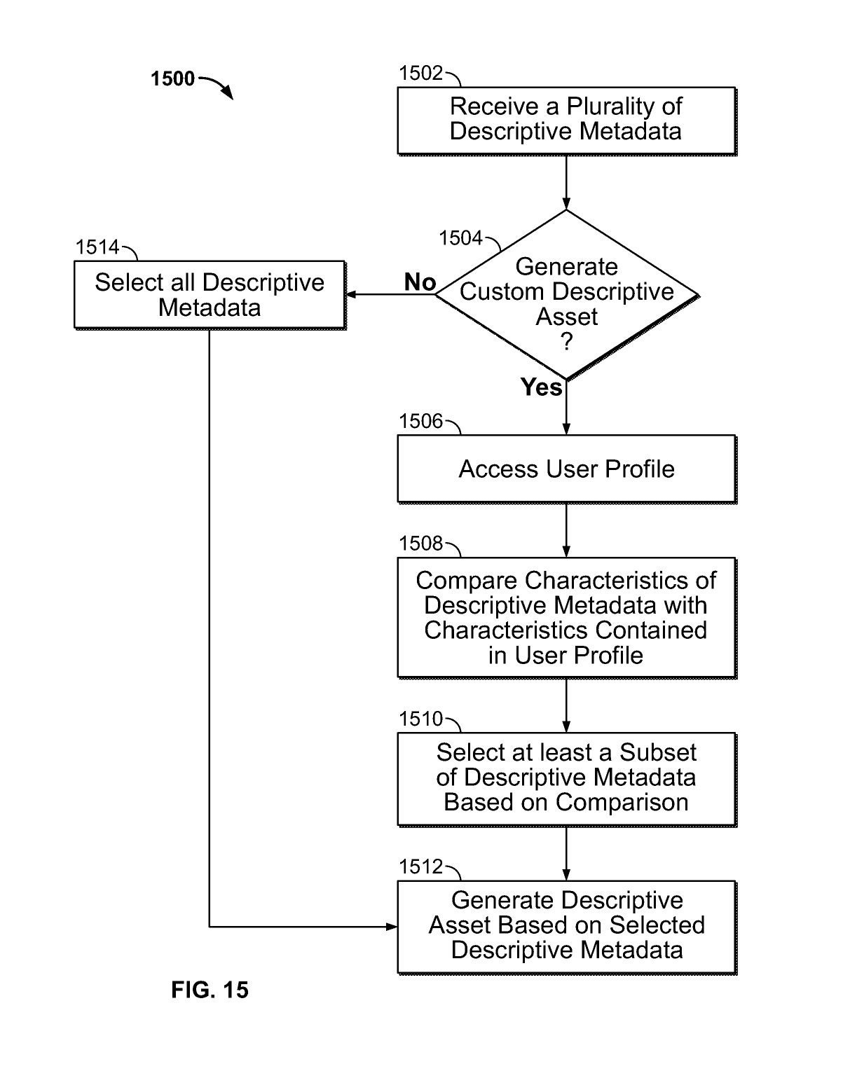

FIG. 15 illustrates a flow diagram 1500 for generating a customized descriptive asset in accordance with some embodiments of the present disclosure. The steps of flow diagram 1500 are performed by a processing device, such as processing circuitry 306 of user equipment 300. In certain embodiments, a similar processing device at a remote server, such as the media content source 416 or media guidance data source 418, may perform the steps of flow diagram 1500. In yet other embodiments, the steps of flow diagram 1500 may be performed by a combination of processing devices at one or more of the entities in media guidance system 400.

At step 1502, the processing device may receive descriptive data. Each of the descriptive data may be associated with a characteristic matrix, such as characteristic matrix 500 or 600. The descriptive data may be received prior to a user request for a descriptive asset, or in response to a request for such an asset. At step 1504, the processing device may decide whether to generate a custom descriptive asset. The processing device may query the user through an alert, or may access settings file and determine what setting the user has set for custom descriptive assets. If the processing device determines that the user does not want custom descriptive assets, then the processing device may proceed to step 1514 and select all descriptive data for generation of the descriptive asset at step 1512. If the processing device determines that the user wants custom descriptive assets, the processing device may proceed to step 1506 and access a user profile. The user profile may contain characteristics and preferences associated with the user, as discussed above in relation to user profile screens 700 and 800.

At step 1508, the processing device may compare the characteristics associated with the descriptive data with characteristics contained in the user profile. In some embodiments, the comparison may entail determining how many characteristics are in common between the descriptive data and the user. For example, the processing device may determine that the characteristic matrix and the user profile both list the same three genres. In other embodiments, the comparison may entail a quantitative calculation. For example, the characteristics in the characteristic matrix and user profile may be numeric values. In such embodiments, the processing device may be able to calculate a quantitative number representing the similarity between the descriptive asset and the user.

In some embodiments, the processing device may calculate a similarity value for each descriptive data. As described above, the similarity value can simply be the number of characteristic matches between the characteristic matrix of the descriptive data and the user profile. In such embodiments, a higher similarity value for a descriptive data represents more characteristic matches, and thus a closer match to the user profile. In other embodiments, the similarity value may be a quantitative number. For example, when the characteristics are numerical values, the processing device may calculate a least-squares distance between the characteristics of the descriptive data and the characteristics of the user profile. For example, the processing device may calculate a least-squares distance by subtracting, for each corresponding characteristic, the numerical value in the user profile with the value associated with the data, squaring each of these differences, summing the squared differences, and taking the square root of the sum. In such embodiments, a lower similarity value indicates a lower least-squares distance, and thus a higher match to the user's preferences.

At step 1510, the processing device may select at least a subset of the descriptive data based on the comparison. In some embodiments, the processing circuitry 306 selects a subset of the descriptive metadata with similarity values that exceed a certain threshold. This threshold may be a user-specified value which is input, for example, into general settings screen 900, or pre-determined by a content provider or service provider. In some embodiments, certain descriptive data may automatically be selected for generation of a descriptive asset. For example, a service provider may require a certain sentence be included in the review as a standard introduction to the review.

In some embodiments, two or more descriptive data may be marked as alternatives. These alternatives may be mutually exclusive, such that selection of one of the set of alternatives automatically precludes the others from being selected. Such alternatives may be marked, for example, in characteristic matrix 500.

In some embodiments, a length constraint limits the number of descriptive data that may be selected. For example, if the user has indicated in the profile that they dislike long reviews, the descriptive asset may be limited to a certain number of words, sentences, or paragraphs. As another illustrative example, if there is limited space on the display 312 of user equipment 300, it may be desirable to limit the length or size of the descriptive asset so that it can fit on the screen. The length constraint may be explicitly specified by the user, for example as an input into general settings screen 900, or may be a pre-defined value, for example set by a content provider or service provider. If the selected subset of descriptive data exceeds the length constraint, certain descriptive data may be de-selected until the selected subset is within the length constraint. Such a process may be limited by the number of descriptive data which are required to be included. Should a conflict occur, the user may be notified, for example through an on-screen alert, that a shorter descriptive asset could not be generated.

At step 1512, the processing device may generate a descriptive asset based on the selected descriptive data. If the user did not want a custom descriptive asset, the processor may either present a full review or generate a descriptive asset based on all of the received descriptive data. Such a generated descriptive asset may be equivalent to the “full review”.

If the user indicated a preference for custom descriptive assets, the processing device may combine the selected descriptive data to generate a custom descriptive asset. In some embodiments, processing circuitry 306 assembles the customized descriptive assets in no particular order. In other embodiments, the descriptive data may have a characteristic which describes a preferred location. For example, a descriptive data may be marked as an “introduction,” and thus included at the beginning. Other possibilities include descriptive data intended as part of the “body”, “conclusion”, or a specific location or time into the descriptive asset. In some embodiments, certain descriptive data may be marked as alternatives to each other. Extending the “introduction” example above, a second descriptive data may be marked as an “introduction” and used interchangeably with the first descriptive data. In some embodiments, the interchangeable data may be mutually exclusive, that is, only one may be included in the descriptive asset. In such embodiments, the processing circuitry 306 may determine which descriptive data to include in the descriptive asset by comparing the other characteristics of the descriptive data with the user profile to determine the best match.

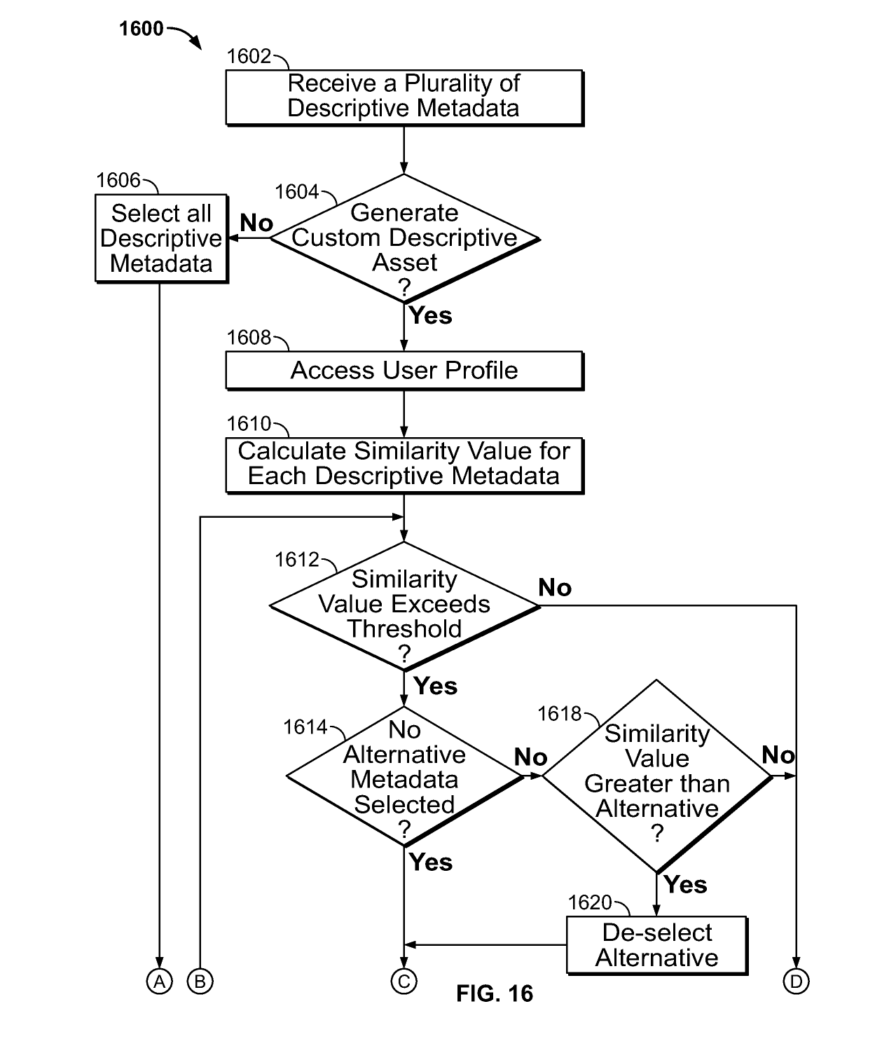

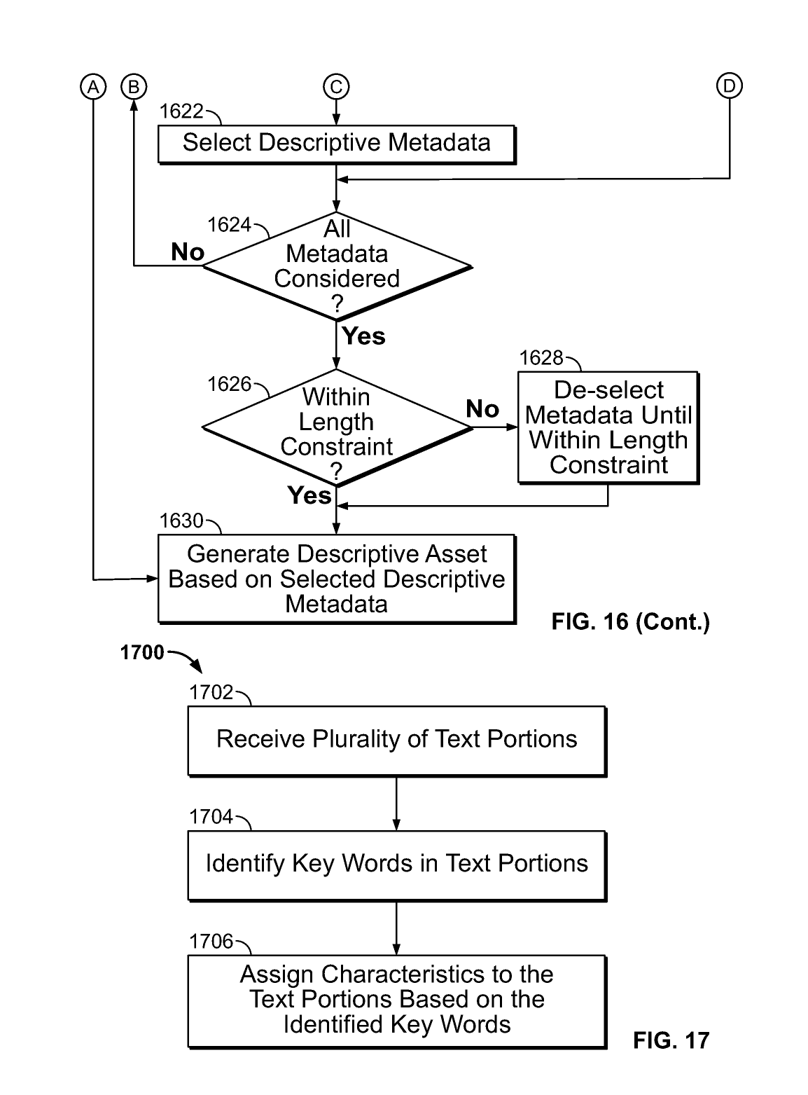

FIG. 16 illustrates a flow diagram 1600 for generating a customized descriptive asset in accordance with some embodiments of the present disclosure. The steps of flow diagram 1600 are performed by a processing device, such as processing circuitry 306 of user equipment 300. In certain embodiments, a similar processing device at a remote server, such as the media content source 416 or media guidance data source 418, may perform the steps of flow diagram 1600. In yet other embodiments, the steps of flow diagram 1600 may be performed by a combination of processing devices at one or more of the entities in media guidance system 400.

At step 1602, the processing device may receive descriptive data. Each of the descriptive data may be associated with a characteristic matrix, such as characteristic matrix 500 or 600. The descriptive metadata may be received prior to a user request for a descriptive asset, or in response to a request for such an asset. At step 1604, the processing device may decide whether to generate a custom descriptive asset. The processing device may query the user through an alert, or may access settings file and determine what setting the user has set for custom descriptive assets. If the processing device determines that the user does not want custom descriptive assets, then the processing device may proceed to step 1606 and select all descriptive data for generation of the descriptive asset at step 1630. If the processing device determines that the user wants custom descriptive assets, the processing device may proceed to step 1608 and access a user profile. The user profile may contain characteristics and preferences associated with the user, as discussed above in relation to user profile screens 700 and 800.

At step 1610, the processing device may calculate a similarity value for each descriptive data. In some embodiments, the similarity value may simply be the number of characteristic matches between the characteristic matrix of the descriptive data and the user profile. In such embodiments, a higher similarity value for a descriptive data represents more characteristic matches, and thus a closer match to the user profile. In other embodiments, the similarity value may be a quantitative number. For example, when the characteristics are numerical values, the processing device may calculate a least-squares distance between the characteristics of the descriptive data and the characteristics of the user profile. For example, the processing device may calculate a least-squares distance by subtracting, for each corresponding characteristic, the numerical value in the user profile with the value associated with the data, squaring each of these differences, summing the squared differences, and taking the square root of the sum. In such embodiments, a lower similarity value indicates a lower least-squares distance, and thus a higher match to the user's preferences.

Steps 1612 through 1628 describe the selection process for selecting at least a subset of descriptive data. At step 1612, the processing device determines whether a similarity value associated with a descriptive data exceeds a threshold. This threshold may be a user-specified value which is input, for example, into general settings screen 900, or pre-determined by a content provider or service provider. If the similarity value does not exceed the threshold, the processing device proceeds to step 1624. If the similarity value exceeds the threshold, the processing device proceeds to step 1614.

At step 1614, the processing device determines whether the descriptive data has any alternatives, and whether any alternatives have been selected. For example, two or more descriptive data may be marked as alternatives. These alternatives may be mutually exclusive, such that selection of one of the set of alternatives automatically precludes the others from being selected. Such alternatives may be marked, for example, in characteristic matrix 500. If no alternative data are selected, or there are no marked alternatives, the processing device may proceed to step 1622. If there is an alternative selected, the processing device proceeds to step 1618 and compares the similarity values of the alternatives. At step 1618, the processor selects the descriptive data with the closest similarity value to the user (either highest or lowest depending on how the similarity value is calculated) and de-selects the data that is further from the user's preferences at step 1620. In some embodiments, one or more of the alternatives may be marked as required for any generated descriptive assets. These alternatives are automatically selected despite their similarity values.

The processing device selects the descriptive data for generation of a descriptive asset at step 1622 and proceeds to step 1624. If all descriptive data have yet to be considered, the processing device returns to step 1612 to consider the next descriptive data. If all descriptive data have been considered, the processing device proceeds to step 1626. At step 1626, the processing device determines whether there is a length constraint, and if so, whether the selected descriptive data exceed the length constraint. If the selected descriptive data is not within the length constraint, the processing device de-selects data until the set of selected data is within the length constraint. Any descriptive data marked as required for generation are automatically selected and cannot be de-selected. Should a conflict occur, the user may be notified, for example through an on-screen alert, that a shorter descriptive asset could not be generated.

Once the selected descriptive data is within the length constraint, the processing device generates the descriptive asset. If the user did not want a custom descriptive asset, the processor may either present a full review or generate a descriptive asset based on all of the received descriptive data. Such a generated descriptive asset may be equivalent to the “full review”.

If the user indicated a preference for custom descriptive assets, the processing device may compile the selected descriptive data to generate a custom descriptive asset. In some embodiments, processing circuitry 306 assembles the customized descriptive assets in no particular order. In other embodiments, the descriptive data may have a characteristic which describes a preferred location. For example, a descriptive data may be marked as an “introduction,” and thus included at the beginning. Other possibilities include descriptive data intended as part of the “body”, “conclusion”, or a specific location or time into the descriptive asset. In some embodiments, certain descriptive data may be marked as alternatives to each other. Extending the “introduction” example above, a second descriptive data may be marked as an “introduction” and used interchangeably with the first descriptive data. In some embodiments, the interchangeable data may be mutually exclusive, that is, only one may be included in the descriptive asset. In such embodiments, the processing circuitry 306 may determine which descriptive data to include in the descriptive asset by comparing the other characteristics of the descriptive data with the user profile to determine the best match.

FIG. 17 illustrates a flow diagram 1700 for assigning characteristics to a text portion in accordance with some embodiments of the present disclosure. The steps of flow diagram 1700 are performed by a processing device, such as processing circuitry 306 of user equipment 300. In certain embodiments, a similar processing device at a remote server, such as the media content source 416 or media guidance data source 418, may perform the steps of flow diagram 1700. In yet other embodiments, the steps of flow diagram 1700 may be performed by a combination of processing devices at one or more of the entities in media guidance system 400.

At step 1702, the processing device may receive text portions. Each of the text portions may be associated with a characteristic matrix, such as characteristic matrix 500 or 600. The text portions may be received prior to a user request for a descriptive asset, or in response to a request for such an asset.

At step 1704, the processing device may identify key words in the text portions. The processing device may access a user profile to compile a list of key words that are associated, for example, with the user's preferences. The processing device may then search the text portions for the occurrence of such key words. For example, the processing device may automatically determine, from the user profile, that the user dislikes plane crashes. The processing device may identify keywords such as “plane”, “crash”, and “airplane” in the text portions. In some embodiments, the processing device may access a database of key words and search the text portions for the occurrence of those key words. The database may be stored at a remote server, for example media content source 416 or media guidance data source 418.

At step 1706, may assign characteristics to the text portions based on the identified key words. In some embodiments, assigning characteristics may entail storing the key words in a characteristics matrix, such as characteristic matrix 500, associated with the text portion.

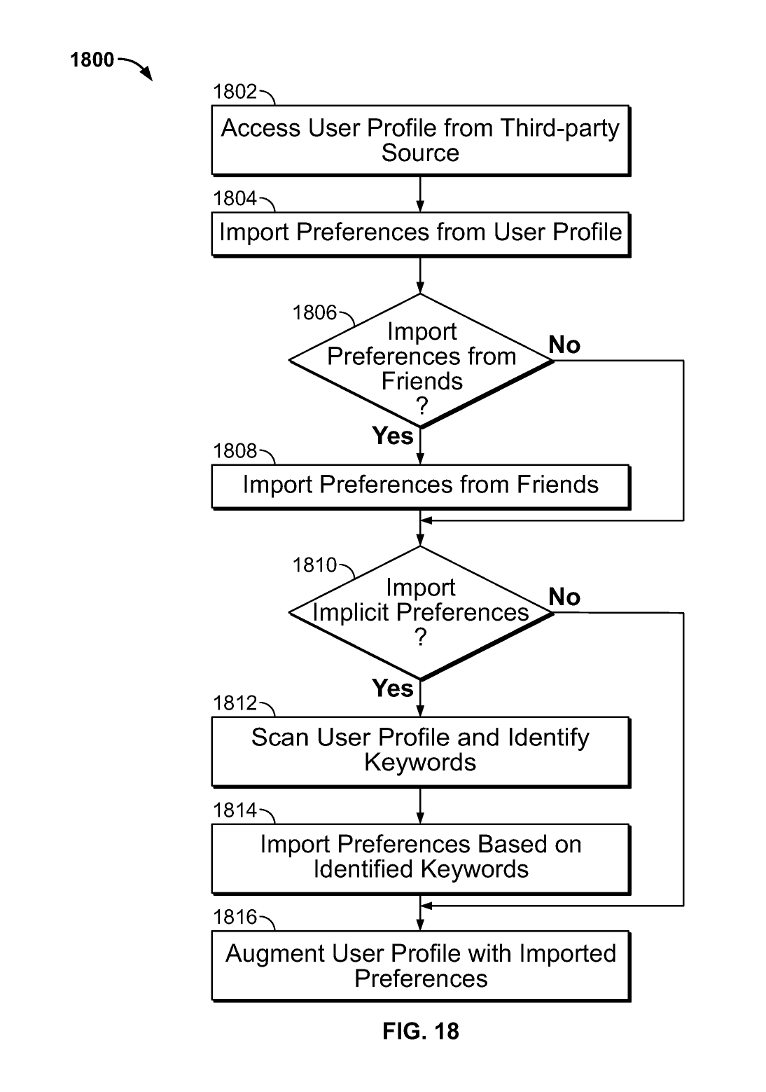

FIG. 18 illustrates a flow diagram 1800 for importing preferences from third party sources in accordance with some embodiments of the present disclosure. The steps of flow diagram 1800 are performed by a processing device, such as processing circuitry 306 of user equipment 300. In certain embodiments, a similar processing device at a remote server, such as the media content source 416 or media guidance data source 418, may perform the steps of flow diagram 1800. In yet other embodiments, the steps of flow diagram 1800 may be performed by a combination of processing devices at one or more of the entities in media guidance system 400.

At step 1802, the processing device may access a user profile from a third-party source. Examples of third-party sources include, among others, Facebook™, Twitter™, Netflix™, and Hulu™. At step 1804, the processing device may import preferences from the third-party profile. For example, the processing circuitry 306 may access a Facebook™ profile associated with the user to determine the user's favorite movies. As another illustrative example, the processing circuitry 306 may access a Netflix™ queue or Hulu™ subscription associated with the user to determine a user's preferences or favorite media. As yet another illustrative example, the processing circuitry 306 may access a Twitter™ feed associated with the user to identify the user's media preferences.

At step 1806, the processing device may determine whether the user wishes to import preferences from people in the user's social group, such as Facebook™ friends. The processing device may query the user, for example with an on-screen alert, or access a settings file, such as one associated with general settings screen 900, to determine whether the user has specified a setting regarding importing preferences from people in the user's social group. If the user has indicated not to import these preferences, the processing device proceeds to step 1810. If the user has indicated to import preferences from the user's social group, the processing device may import preferences from these profiles at step 1808 in a similar manner as described in relation to step 1804.

At step 1810, the processing device may determine whether the user wishes to import implicit preferences. The processing device may query the user, for example with an on-screen alert, or access a settings file, such as one associated with general settings screen 900, to determine whether the user has specified a setting regarding implicit preferences. If the user has indicated not to import implicit preferences, the processing device may proceed to step 1816. If the user has indicated to import implicit preferences, the processing device may scan the third-party profile for certain keywords at step 1812. The processing device may then assign characteristics to the user profile based on the identified keywords at step 1814. For example, the processing device may identify the words “beach” and “vacation” and add those to the content characteristics that the user might be interested in. As another illustrative example, the processing device may identify keywords indicative of certain life events, such as the birth of a new child, and assign a preference to the user profile based on the identified life event. Implicit preferences from other profiles in the user's social group may be imported in a similar fashion.

At step 1816, the processing device may augment the user profile with the imported preferences. In some embodiments, augmenting the user profile may entail storing the key words in a user profile, such as the user profile associated with user profile screen 700.

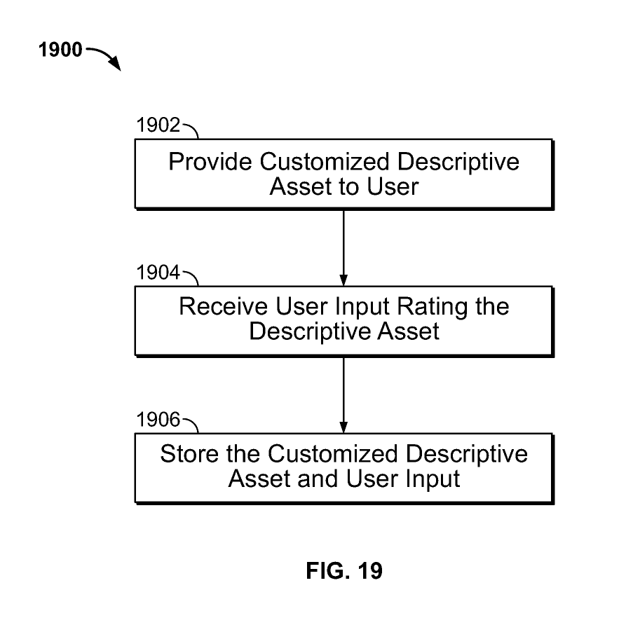

FIG. 19 illustrates a flow diagram 1900 for storing a customized descriptive asset in accordance with some embodiments of the present disclosure. The steps of flow diagram 1900 are performed by a processing device, such as processing circuitry 306 of user equipment 300. In certain embodiments, a similar processing device at a remote server, such as the media content source 416 or media guidance data source 418, may perform the steps of flow diagram 1900. In yet other embodiments, the steps of flow diagram 1900 may be performed by a combination of processing devices at one or more of the entities in media guidance system 400.

At step 1902, the processing device may provide a customized descriptive asset to a user in any suitable manner. For example, for a text summary, review, or other description, the customized descriptive asset may be displayed on display 312 of user equipment 300. The text description may also be converted by a text-to-speech converter and read aloud to the user through speakers 314 of user equipment 300. For a video review, trailer, or other visual assets, the descriptive asset may be played on user equipment 300. Similarly, audio descriptive assets may be played on speakers 314. Furthermore, the descriptive asset may include a combination of media, such as a customized text review with embedded graphics and a custom song playing in the background.

At step 1904, the processing device may receive a user input rating the descriptive asset. For example, the screen which presents the descriptive asset may include an area which allows the user to input a rating and/or any comments the user may have. In other embodiments, the processing device may query the user with an on-screen alert. For example, an on-screen alert may ask the user to rate the usefulness or quality of the customized descriptive asset.

At step 1906, the processing device may store the generated descriptive asset, either locally on a user's equipment 300, or remotely at media content source 416, media guidance data source 418, or another remote server. In some embodiments, the user rating may be stored with the descriptive asset. A content provider may analyze the user ratings and customized descriptive assets, for example, for use in other applications or advertising campaigns.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for providing a customized descriptive asset, comprising:
receiving a plurality of descriptive data related to a media asset, wherein each descriptive data is associated with one or more characteristics;
accessing a profile associated with a user, wherein the profile includes user preferences for characteristics of media assets;
comparing the preferences included in the profile with the characteristics associated with the descriptive data;
selecting at least a subset of the descriptive data based on the comparison; and
assembling the selected descriptive data to generate a descriptive asset which provides a narrative account related to the content of the media asset.

2. The method of claim 1, wherein the descriptive data is selected from the group consisting of: a text portion, a video clip, an audio clip, and a graphic.

3. The method of claim 1, wherein the descriptive data is a text portion, and further comprising searching the plurality of descriptive data for keywords and assigning characteristics to the descriptive data based on the search.

4. The method of claim 1, wherein the characteristics associated with the descriptive data and the preferences included in the profile comprise numerical values, and wherein comparing the preferences included in the profile with the characteristics associated with the descriptive data comprises calculating a similarity value.

5. The method of claim 4, wherein selecting at least a subset of the descriptive data comprises selecting at least a subset of the descriptive data with similarity values that exceed a threshold.

6. The method of claim 4 wherein the similarity value is a least-squares distance.

7. The method of claim 1, wherein the descriptive asset is selected from the group consisting of: a text synopsis, a text review, a video preview, a video review, an audio preview, an audio review, and a graphic.

8. The method of claim 1, wherein the characteristics associated with the descriptive data are selected from the group consisting of: a genre, a parental rating, a mood, a content category, an actor/actress, target demographic information, and a preferred location in the descriptive asset.

9. The method of claim 1, wherein the preferences included in the profile are selected from the group consisting of: a genre, a parental rating, a mood, a content category, an actor/actress, an age group, user demographic information, a user gender, and a user location.

10. The method of claim 1, further comprising accessing a second profile from a third-party source and augmenting the profile associated with the user with preferences from the second profile.

11. The method of claim 1, wherein assembling the selected descriptive data to generate a descriptive asset occurs at a user equipment.

12. The method of claim 1, wherein assembling the selected descriptive data to generate a descriptive asset occurs at a server remote from a user equipment.

13. A system for providing a customized descriptive asset, comprising:
a processor configured to:
receive a plurality of descriptive data related to a media asset, wherein each descriptive data is associated with one or more characteristics;
access a profile associated with a user, wherein the profile includes user preferences for characteristics of media assets;
compare the preferences included in the profile with the characteristics associated with the descriptive data;
select at least a subset of the descriptive data based on the comparison; and
assemble the selected descriptive data to generate a descriptive asset which provides a narrative account related to the content of the media asset.

14. The system of claim 13, wherein the descriptive data is selected from the group consisting of: a text portion, a video clip, an audio clip, and a graphic.

15. The system of claim 13, wherein the descriptive data is a text portion, and wherein the processor is further configured to search the plurality of descriptive data for keywords and assign characteristics to the descriptive data based on the search.

16. The system of claim 13, wherein the characteristics associated with the descriptive data and the preferences included in the profile comprise numerical values, and wherein the processor is configured to compare the preferences included in the profile with the characteristics associated with the descriptive data by calculating a similarity value.

17. The system of claim 16, wherein the processor is configured to select at least a subset of the descriptive data by selecting at least a subset of the descriptive data with similarity values that exceed a threshold.

18. The system of claim 16 wherein the similarity value is a least-squares distance.

19. The system of claim 13, wherein the descriptive asset is selected from the group consisting of: a text synopsis, a text review, a video preview, a video review, an audio preview, an audio review, and a graphic.

20. The system of claim 13, wherein the characteristics associated with the descriptive data are selected from the group consisting of: a genre, a parental rating, a mood, a content category, an actor/actress, target demographic information, and a preferred location in the descriptive asset.

21. The system of claim 13, wherein the preferences included in the profile are selected from the group consisting of: a genre, a parental rating, a mood, a content category, an actor/actress, an age group, user demographic information, a user gender, and a user location.

22. The system of claim 13, wherein the processor is further configured to access a second profile from a third-party source and augment the profile associated with the user with preferences from the second profile.

23. The system of claim 13, wherein the processor is configured to assemble the selected descriptive data to generate a descriptive asset at a user equipment.

24. The system of claim 13, wherein the processor is configured to assemble the selected descriptive data to generate a descriptive asset at a server remote from a user equipment.

25-36. (canceled)
